(19) United States
(12) Patent Application Publication
(10) Pub. No.: US 2009/0154980 A1
(43) Pub. Date: Jun. 18, 2009

(54) DESIGN STRUCTURE FOR CONTROLLING SHARED ACCESS OF A MEDIA TRAY

(76) Inventors: CANDICE L. COLETRANE, Durham, NC (US); Eric R. Kern, Chapel Hill, NC (US); Chambrea Little, Raleigh, NC (US); Robyn A. McGlotten, Durham, NC (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 12/113,646

(22) Filed: May 1, 2008

Related U.S. Application Data
(63) Continuation-in-part of application No. 11/956,224, filed on Dec. 13, 2007.

(51) Int. Cl. B41J 11/42

(52) U.S. Cl. 400/624

(57) ABSTRACT

A design structure embodied in a machine readable storage medium for designing, manufacturing, and/or testing a design for controlling shared access of a media tray is disclosed. The design structure includes operations that include monitoring communications between a virtualized media tray and a computing device currently connected to the virtualized media tray; receiving an access request from a requesting computing device not currently connected to the virtualized media tray; determining, in dependence upon the monitored communications between the virtualized media tray and the computing device currently connected to the virtualized media tray, to switch connection of the virtualized media tray from the computing device currently connected to the virtualized media tray to the requesting computing device; and switching connection of the virtualized media tray from the computing device currently connected to the virtualized media tray to the requesting computing device.

### CROSS-REFERENCE TO RELATED APPLICATIONS

This application is a continuation-in-part of co-pending U.S. patent application Ser. No. 11/956,224, filed Dec. 13, 2007, which is herein incorporated by reference.

### BACKGROUND OF THE INVENTION

1. Field of the Invention

The field of the invention is generally related to design structures, and more specifically, design structures for controlling shared access of a media tray.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Typical systems today may include many computing devices. To reduce cost, a group of computing devices, such as blade servers in a blade center, may share some computer resources. Such shared computer resources include, for example, hard drives, floppy disk drives, CD-ROM drives, and DVD-Rom drives. In typical blade centers several blade servers share access to a Universal Serial Bus media tray. Each of the blade servers includes a hardware button that when pressed by user causes the connection of the media tray to be redirected to the blade server having the pressed button. This switch currently occurs whether or not the media tray is use by another blade server. Switching the connection of the media tray from one blade server to another in many instances, such as during the installation of an operating system, may cause a critical interruption in the use of the media tray.

### SUMMARY OF THE INVENTION

Methods, apparatus, and products for controlling shared access of a media tray are disclosed that include monitoring communications between a virtualized media tray and a computing device currently connected to the virtualized media tray; receiving an access request from a requesting computing device not currently connected to the virtualized media tray; determining, in dependence upon the monitored communications between the virtualized media tray and the computing device currently connected to the virtualized media tray, to switch connection of the virtualized media tray from the computing device currently connected to the virtualized media tray to the requesting computing device; and switching connection of the virtualized media tray from the computing device currently connected to the virtualized media tray to the requesting computing device.

In one embodiment, a design structure embodied in a machine readable storage medium for at least one of designing, manufacturing, and testing a design is provided. The design structure generally includes an apparatus for controlling shared access of a media tray. The media tray may be connected to a management module, virtualized by the management module, and connected to a plurality of computing devices for sharing. The apparatus generally includes a computer processor and a computer memory operatively coupled to the computer processor. The computer memory may have computer program instructions disposed within it capable of monitoring communications between the virtualized media tray and a computing device currently connected to the virtualized media tray, receiving an access request from a requesting computing device not currently connected to the virtualized media tray, determining, in dependence upon the monitored communications between the virtualized media tray and the computing device currently connected to the virtualized media tray, to switch connection of the virtualized media tray from the computing device currently connected to the virtualized media tray to the requesting computing device, and switching connection of the virtualized media tray from the computing device currently connected to the virtualized media tray to the requesting computing device.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a functional block diagram of an exemplary system capable of controlling shared access of a media tray according to embodiments of the present invention.

FIG. 2 sets forth a functional block diagram of a system for controlling shared access of a media tray in accordance with the present invention.

FIG. 3 sets forth a flow chart illustrating an exemplary method for controlling shared access of a media tray according to embodiments of the present invention.

FIG. 4 is a flow diagram of a design process used in semiconductor design, manufacture, and/or test.

### DETAILED DESCRIPTION OF EXEMPLARY EMBODIMENTS

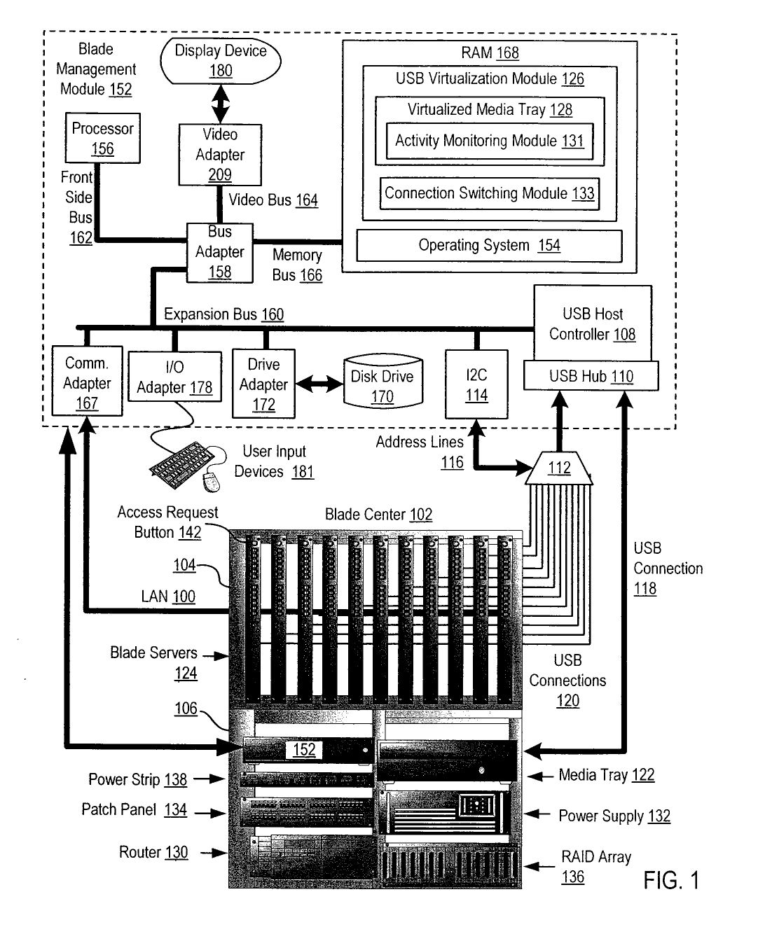

Exemplary methods, apparatus, and products for controlling shared access of a media tray in accordance with the present invention are described with reference to the accompanying drawings, beginning with FIG. 1. FIG. 1 sets forth a functional block diagram of an exemplary system capable of controlling shared access of a media tray (122) according to embodiments of the present invention. Typical media trays include Compact Disc read-only media drives (‘CD-ROM’), Digital Video Disc ROM drives (DVD-ROM), CD-RW drives, DVD-RW drives, floppy disk drives, and so on as will occur those of skill in the art. The exemplary media tray (122) in the exemplary system of FIG. 1 is a USB media device, such as a USB CD-ROM drive. The media tray (122) in the system of FIG. 1 is installed in a blade center (102) that includes two cabinet bays (104, 106).

Installed in cabinet bay (104) of the exemplary blade center (102) in the system of FIG. 1 are several computing devices implemented in blade form factor, depicted in FIG. 1 as blade servers (124). The blade servers installed in the exemplary blade center (102) share access to the media tray (122). The blade servers (124) are connected to one another for data communications through a local area network (‘LAN’) (100). Readers of skill in the art will recognize that the blade servers may also be connected to other components in the blade center through the LAN (100) or other computing devices through a wide area network (‘WAN’) not shown in FIG. 1.

Installed in cabinet bay (106) of the exemplary blade center (102) in the system of FIG. 1 is a data communications network router (130), a patch panel (134), a Redundant Array of Independent Disks (‘RAID’) (136), a power supply (132), a power strip (138), a media tray (122), and a management module depicted in the system of Figure as a blade management module (152). The blade management module (152) provides system management functions for all components in the exemplary blade center (102) including the blade servers (124) and the media tray (122).

Controlling shared access of a media tray (122) in accordance with the present invention is generally implemented with computers, that is, with automated computing machinery. In the system of FIG. 1, for example, the blade servers (124) and blade management module (152) installed in the blade center (102) are implemented to some extent at least as computers. The blade management module (152) of FIG. 1 includes at least one computer processor (156) or ‘CPU’ as well as random access memory (168) (‘RAM’) which is connected through a high speed memory bus (166) and bus adapter (158) to processor (156) and to other components of the blade management module (152).

The blade management module (152) of FIG. 1 includes a Universal Serial Bus (‘USB’) host controller (108). The media tray (122) installed in the exemplary blade center (102) is connected to the USB host controller (108) in the blade management module through a USB connection (118) and a USB hub (110). The USB architecture provides a serial bus standard for connecting together devices such as, for example, computers, game consoles, personal digital assistants, televisions, stereo equipment, and so on. The Universal Serial Bus Specification Revision 2.0 (‘USB Specification’) jointly authored by Compaq™, Hewlett-Packard™, Intel™, Lucent™, Microsoft™, NEC™, and Philips™ sets forth the standard for developing USB components and communicating among the components. USB components include, for example, devices, cables, hubs, hosts, ports, interfaces, mass storage devices, and so on. In USB terminology, the exemplary blade management module (152) containing the host controller (108) is referred to as a ‘host.’ The USB host controller (108) provides an interface for other components of the exemplary blade management module (152) to utilize USB hubs and USB devices connected to the USB host controller (108). The USB host controller (402) may be implemented as a combination of hardware, firmware, or software. The exemplary USB host controller (108) of FIG. 1 controls the USB hub (110). A USB hub is a device that allows many USB devices to be connected to a single USB port on a host computer or another hub.

Stored in RAM (168) is a Universal Serial Bus (‘USB’) virtualization module (126), a module of computer program instructions that operates generally for presenting a virtualized media tray a and controlling shared access of the media tray in accordance with embodiments of the present invention. The virtualization module (126) includes computer program instructions capable of virtualizing the actual media tray (122) and presenting the virtualized media tray through one of the USB connections (120) to one of the blade servers (124) installed in the exemplary blade center as a USB mass storage device. A USB mass storage device is device that implements the USB mass storage device class (‘USB MSC’). The USB MSC is set of computing communications protocols defined by the USB Implementers Forum that run on the Universal Serial Bus. The standard provides an interface to a variety of storage devices. Some of the devices which are connected to computers via this standard include:
external magnetic hard drives;
external optical drives, including CD and DVD reader and writer drives;
portable flash memory devices, particularly keydrives;
adapters bridging between standard flash memory cards and a USB connection;
digital cameras;
digital audio players high-end hardware media players;
Card Readers;
Portable Gaming systems;
personal data assistants and handheld computers;
some newer mobile phones, such as the Sony Ericsson K800 and K510, Nokia N73, Nokia E61;
USB Keystroke loggers; and
others as will occur to those of skill in the art.

The virtualized mass storage device is presented to one of the blade servers through the multiplexer (112). A multiplexer is a device capable of connecting, through an internal connection, one particular signal line to one of a plurality of signal lines. Each blade server in the exemplary system of FIG. 1 is connected to the multiplexer (112) through a USB connection (120). Each blade center is associated with a unique address. When such a unique address is transmitted to the multiplexer through address lines (116), the multiplexer switches an internal connection to the USB connection (120) of the blade server associated with that unique address, thereby connecting that blade server to the USB host controller (108) and virtualized media tray (128).

As mentioned above, the exemplary USB virtualization module (126) in the system of FIG. 1 operates generally for controlling shared access to a media tray in accordance with embodiments of the present invention. In the exemplary system of FIG. 1, the USB virtualization module (126) includes an activity monitoring module (131). The activity monitoring module (131) includes computer program instructions capable of monitoring communications between the virtualized media tray (128) and a computing device currently connected to the virtualized media tray (128). The activity monitoring module (131) of FIG. 1 is depicted as a separate software component in the USB virtualization module (128) for clarity, not for limitation. Readers of skill in the art will recognize that all functionality provided by the activity monitoring module may be provided by computer program instructions included in the USB virtualization module (126).

The USB virtualization module (126) also includes computer program instructions capable of: receiving an access request from a requesting computing device not currently connected to the virtualized media tray. Each of the blade servers in the system of FIG. 1 includes an access request button (142) that when pressed by a user initiates sending by the blade server an access request for the media tray. In some embodiments, each blade server is associated with a service processor, called a baseboard management controller (‘BMC’), installed in the blade center. The blade severs may transmit an access request to the blade management module through their associated service processor. In other alternative embodiments, such as the embodiment depicted in the system of FIG. 1, the blade servers may transmit an access request to the blade management module through the LAN (100).

The USB virtualization module (126) also includes a connection switching module (133). The connection switching module (133) includes computer program instructions capable of: determining, in dependence upon the monitored communications between the virtualized media tray (128) and the computing device currently connected to the virtualized media tray (128), to switch connection of the virtualized media tray (128) from the computing device currently connected to the virtualized media tray (128) to the requesting computing device (210); and switching (308) connection of the virtualized media tray (128) from the computing device (212) currently connected to the virtualized media tray (128) to the requesting computing device (210). The connection switching module (133) is depicted as a separate software component in the USB virtualization module (128) for clarity, not for limitation. Readers of skill in the art will recognize that all functionally provided by the connection switching module (133) may be provided by computer program instruction included in the USB virtualization module (126).

In embodiments having a separate BMC associated with each blade server, each BMC is capable, upon instruction from the USB virtualization module (126), of addressing the multiplexer (112) and switching connection of the virtualized media tray (128) to the requesting blade server. In other alternative embodiments, such as the embodiment depicted in the system of FIG. 1, the multiplexer is switched by the connection switching module (133) of the USB virtualization module (126), through an out-of-band communications link, such as an I-squared-C (‘I²C’) communications link (114).

Also stored in RAM (168) is an operating system (154). Operating systems useful for controlling shared access of a media tray according to embodiments of the present invention include UNIX™, Linux™, Microsoft XP™, Microsoft Vista™, AIX™, IBM's i5/OS™, and others as will occur to those of skill in the art. The operating system (154), USB virtualization module (126), activity monitoring module (131), and connection switching module (133) in the example of FIG. 1 are shown in RAM (168), but many components of such software typically are stored in non-volatile memory also, such as, for example, on a disk drive (170).

The exemplary blade management module (152) of FIG. 1 includes disk drive adapter (172) coupled through expansion bus (160) and bus adapter (158) to processor (156) and other components of the blade management module (152). Disk drive adapter (172) connects non-volatile data storage to the blade management module (152) in the form of disk drive (170). Disk drive adapters useful in computers for controlling shared access of a media tray according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (‘EEPROM’ or ‘Flash’ memory), RAM drives, and so on, as will occur to those of skill in the art.

The exemplary blade management module (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example blade management module (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary blade management module (152) of FIG. 1 includes a communications adapter (167) that couples the blade management module (152) for data communications with other components in the blade center (102) through a local area data communications network (100). Such a data communication network (100) may be implemented with external buses such as a Universal Serial Bus (‘USB’), or as an Internet Protocol (‘IP’) network or an Ethernet™ network, an I²C network, a System Management Bus (‘SMBus’), an Intelligent Platform Management Bus (‘IPMB’), for example, and in other ways as will occur to those of skill in the art. Communications adapters implement the hardware level of data communications through which one computer sends data communications to another computer, directly or through a data communications network. Examples of communications adapters useful for controlling shared access of a media tray according to embodiments of the present invention include modems for wired dial-up communications, Ethernet (IEEE 802.3) adapters for wired data communications network communications and 802.11 adapters for wireless data communications network communications.

The arrangement of servers and other devices making up the exemplary system illustrated in FIG. 1 are for explanation, not for limitation. Data processing systems useful according to various embodiments of the present invention may include additional servers, routers, and other devices, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

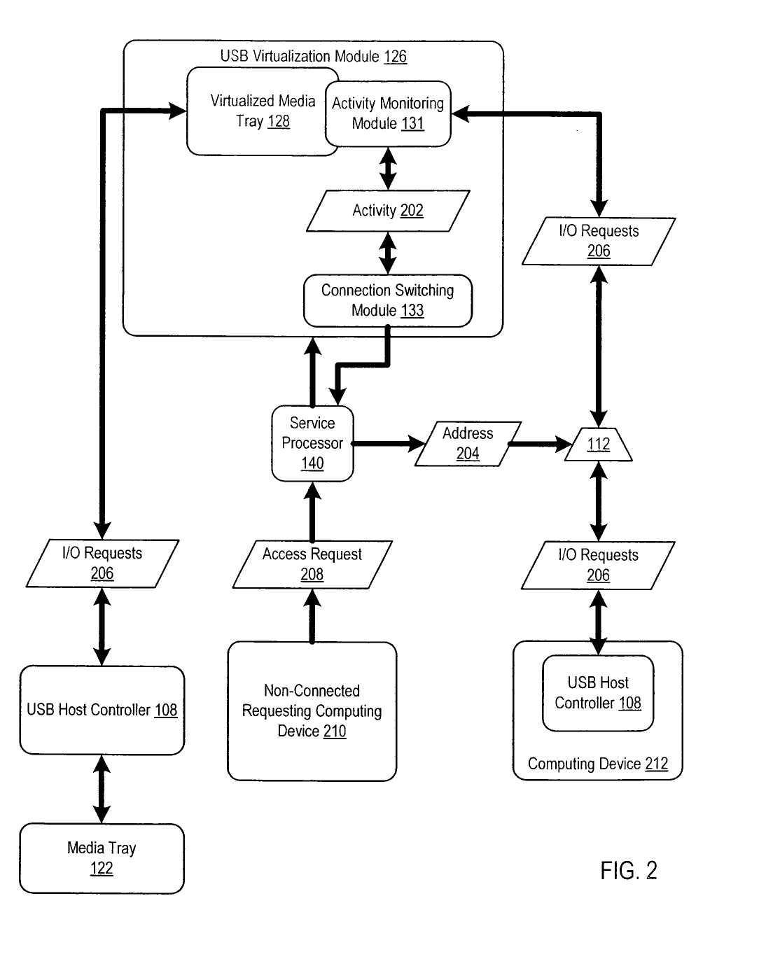

For further explanation, FIG. 2 sets forth a functional block diagram of a system for controlling shared access of a media tray in accordance with the present invention. The system of FIG. 2 includes a USB virtualization module (128). The exemplary USB virtualization module (126) of FIG. 2 is a module of computer program instructions capable of presenting a virtualized media tray and controlling shared access of the media tray in accordance with embodiments of the present invention. The virtualized media tray (128) is a representation in software of an actual media tray and is capable of passing I/O requests (206) to and from the actual media tray (122) for execution. The virtualized media tray (128) is presented to a computing device as an actual media tray. The computing device interacts with the virtualized media tray as if the media tray were an actual media tray. In the system of FIG. 2 for example a computing device (212) is connected to a virtualized media tray (128) through a USB host controller (108) and multiplexer (112). The computing device (212) interacts with the virtualized media tray (128) by transmitting I/O requests (206) to and receiving I/O requests from the virtualized media tray (128). The virtualized media tray forwards received I/O requests (206) through a USB host controller (108) to the actual media tray (122) or transmits I/O requests received from the actual media tray (122) to the computing device (212).

The USB virtualization module (126) of FIG. 2 includes an activity monitoring module (131). The activity monitoring module (131) of FIG. 2 is a module of computer program instructions useful in controlling shared access of the media tray (122). The activity monitoring module (131) is capable of monitoring communications, such as I/O requests (206), between the virtualized media tray (128) and a computing device (212) currently connected to the virtualized media tray (128). The activity monitoring module (131) may monitor communications between the virtualized media tray and the computing device (212) by identifying periods of high or low activity (202) between the virtualized media tray and the computing device currently connected to the virtualized media tray.

The USB virtualization module of FIG. 2 includes computer program instructions capable of receiving an access request (208) from a requesting computing device not currently connected to the virtualized media tray. As mentioned above, in some embodiments each computing device may be associated with a service processor (140). In the system of FIG. 2, for example, the non-connected requesting computing device (210) sends an access request (208) through a service processor (140) to the USB virtualization module (126).

The USB virtualization module also includes a connection switching module (133). The connection switching module (133) of FIG. 2 is a module of computer program instructions capable of determining, in dependence upon the monitored communications between the virtualized media tray (128) and the computing device currently connected to the virtualized media tray (128), to switch connection of the virtualized media tray (128) from the computing device currently connected to the virtualized media tray (128) to the requesting computing device (210). The connection switching module (133) may determine to switch connection of the virtualized media tray (128) from the computing device currently connected to the virtualized media tray (128) to the requesting computing device (210) by determining that a current period of communications between the virtualized media tray and the computing device currently connected to the virtualized media tray is a period of low activity (202).

The exemplary connection switching module (133) of FIG. 2 also includes computer program instructions capable of switching (308) connection of the virtualized media tray (128) from the computing device (212) currently connected to the virtualized media tray (128) to the requesting computing device (210). The connection switching module (133) of Figure may switch (308) connection of the virtualized media tray (128) from the computing device (212) currently connected to the virtualized media tray (128) to the requesting computing device (210) in several ways. If each computing device is associated with a service processor (140), the connection switching module (133) may switch connection of the virtualized media tray by instructing the service processor (140) associated with the requesting computing device (210) to address the multiplexer (112). Each service processor is capable of addressing the multiplexer and may be configured with an address (204) that can be used to switch connection through the multiplexer to the computing device associated with the service processor (140).

If each computing device is not associated with a service processor the connection switching module (133) may switch connection of the virtualized media tray (128) by addressing, through an out-of-band communications link, a multiplexer connecting the virtualized media tray to the plurality of computing devices with an address associated with the requesting computing device. An out-of-band communications link is a communications link for out-of-band communications of data and instructions between a management module and a computing device. Types of communications links useful for such out-of-band communications include:
The System Management Bus (‘SMBus’), a two-wire bus used for communication with low-bandwidth devices on a motherboard, especially power related chips such as a laptop's rechargeable battery subsystem, temperature sensors, and lid switches.
I²C bus, a serial computer bus invented by Philips that is used to for low-speed communications with peripheral components of a system. The name stands for Inter-Integrated Circuit and is pronounced I-squared-C or sometimes as I-two-C.
The Universal Serial Bus (‘USB’), a serial bus standard for communications designed to allow a peripheral to be connected without an expansion cards, and to improve plug-and-play capabilities by allowing devices to be hot-swapped. Originally designed for computers, its flexibility has placed USB buses on video game consoles, PDAs, portable DVD and media players, cellphones, and even devices such as televisions, home stereo equipment, digital audio players, car stereos, and portable memory devices.
Inifiniband link, a point-to-point, bidirectional serial link intended for the connection of processors with high speed peripherals such as storage devices. InfiniBand is the result of merging two competing designs, Future I/O, developed by Compaq, IBM, and Hewlett-Packard, with Next Generation I/O (NGIO), developed by Intel, Microsoft, and Sun. From the Compaq side, the roots were derived from Tandem's ServerNet. For a short time before the group came up with a new name, InfiniBand was called System I/O.
Others as will occur to those of skill in the art.

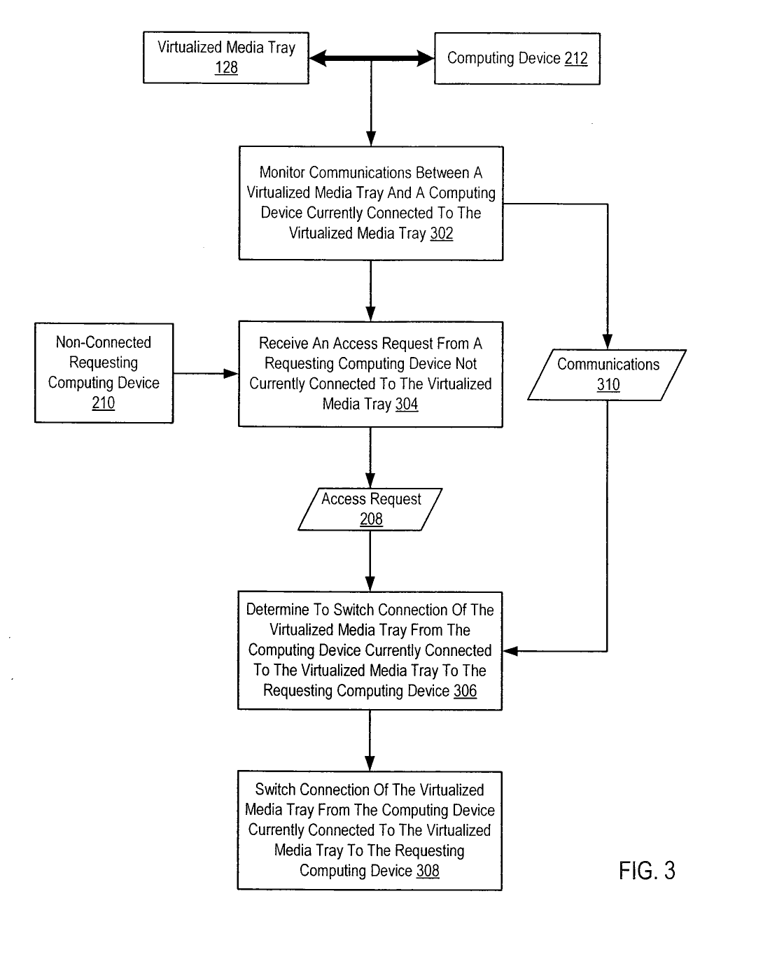

For further explanation, FIG. 3 sets forth a flow chart illustrating an exemplary method for controlling shared access of a media tray according to embodiments of the present invention. In the method of FIG. 3, the media tray is connected to a management module, is virtualized by the management module, and connected to a plurality of computing devices for sharing.

The method of FIG. 3 includes monitoring (302) communications (310) between the virtualized media tray (128) and a computing device (212) currently connected to the virtualized media tray (128). Monitoring (302) communications (310) between the virtualized media tray (128) and a computing device (212) currently connected to the virtualized media tray (128) may be carried out by identifying, by an activity monitoring module, periods of low activity between the virtualized media tray and the computing device currently connected to the virtualized media tray. Identifying periods of low activity may be carried out by snooping Small Computer System Interface (‘SCSI’) commands and responses between the connected computing device and the virtualized media tray and determining that a rate of received, sent, or exchanged SCSI commands and responses during a predetermined amount of time is less than a predetermined threshold. SCSI is a set of standards for physically connecting and transferring data between computers and peripheral devices. The SCSI standards define commands, protocols, and electrical and optical interfaces. SCSI is most commonly used for hard disks and tape drives, but it can also connect a wide range of other devices, including scanners, and optical drives, such as CD-ROM drives or DVD-ROM drives. The SCSI standard contains definitions of command sets of specific peripheral device types. In addition to many different hardware implementations, the SCSI standards also include a complex set of command protocol definitions. The SCSI command architecture was originally defined for parallel SCSI buses but has been carried forward with minimal change for use with iSCSI and serial SCSI. Other technologies which use the SCSI command set include the ATA Packet Interface, USB Mass Storage class, and FireWire SBP-2. Although SCSI commands are described here as communication which may be monitored between a virtualized media tray and a computing device, readers of skill in the art will recognize that other data communications according to various other protocols may be monitored in accordance with embodiments of the present invention.

Monitoring (302) communications (310) between the virtualized media tray (128) and a computing device (212) currently connected to the virtualized media tray (128) may also be carried out by identifying, by the activity monitoring module, no communications between the virtualized media tray and the computing device currently connected to the virtualized media tray for an amount of time greater than a predetermined threshold. That is, connection to the virtualized media tray may not be switched until the activity monitoring module identifies no communications between the computing device and the virtualized media tray for a preconfigured “quite time.” The quite time may be configured by a system administrator.

Monitoring (302) communications (310) between the virtualized media tray (128) and a computing device (212) currently connected to the virtualized media tray (128) may also be carried out by as a combination of the methods of carrying out the monitoring mentioned above. Monitoring communications, for example, may be carried out by identifying periods of high and low activity, and once a period of high activity is identified, only identifying a period of low activity if no communications exist between the computing device and the virtualized media tray for a preconfigured amount of time. In this way, identifying a period of low activity may be delayed for the preconfigured amount of time, the so called “quiet time,” if a period of high activity was previously identified. This delay may takes into account common patterns of device communications which may occur in sporadic periods of high and low activity.

The method of FIG. 3 also includes receiving (304) an access request (208) from a requesting computing device not currently connected to the virtualized media tray. As mentioned above each computing device may includes an access request button, a dedicated piece of hardware, that when pressed by a user initiates sending by the computing device an access request for the media tray. Alternatively, an access request (208) may be sent from the computing device in dependence upon a software event, such as a event caused by pressing a button on a GUI, or in dependence upon an instruction from another software application running on the computing device. The virtualization module may receive an access request through a service processor associated with the computing device, through an out-of-band communications network, or through an in-band data communications network, such as a local area network.

The method of FIG. 3 also includes determining (306), in dependence upon the monitored communications (310) between the virtualized media tray (128) and the computing device (212) currently connected to the virtualized media tray (128), to switch connection of the virtualized media tray (128) from the computing device (212) currently connected to the virtualized media tray (128) to the requesting computing device (210). Determining (306) to switch connection of the virtualized media tray (128) from the computing device (212) currently connected to the virtualized media tray (128) to the requesting computing device (210) may be carried out by determining that a current period of communications between the virtualized media tray and the computing device currently connected to the virtualized media tray is a period of low activity.

The method of FIG. 3 also includes switching (308) connection of the virtualized media tray (128) from the computing device (212) currently connected to the virtualized media tray (128) to the requesting computing device (210). Switching (308) connection of the virtualized media tray (128) from the computing device (212) currently connected to the virtualized media tray (128) to the requesting computing device (210) may be carried out in several ways. Switching connection of the virtualized media tray may be carried out, for example, by addressing, through an out-of-band communications link, a multiplexer connecting the virtualized media tray to the plurality of computing devices with an address associated with the requesting computing device. If each computing device is associated with a service processor, however, switching connection of the virtualized media tray may be carried out by instructing the service processor associated with the requesting computing device (210) to address the multiplexer (112). Each service processor is capable of addressing the multiplexer and may be configured with an address (204) that can be used to switch connection through the multiplexer to the computing device associated with the service processor (140).

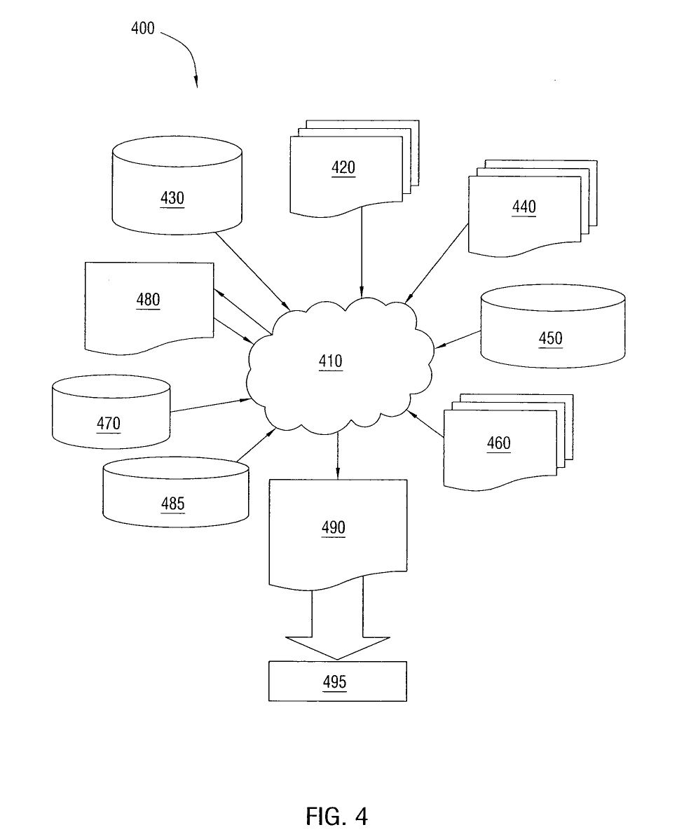

FIG. 4 shows a block diagram of an exemplary design flow (400) used for example, in semiconductor design, manufacturing, and/or test. Design flow (400) may vary depending on the type of IC being designed. For example, a design flow (400) for building an application specific IC (ASIC) may differ from a design flow (400) for designing a standard component. Design structure (420) is preferably an input to a design process (410) and may come from an IP provider, a core developer, or other design company or may be generated by the operator of the design flow, or from other sources. Design structure (420) comprises the circuits described above and shown in FIGS. 1 and 2 in the form of schematics or HDL, a hardware-description language (e.g., Verilog, VHDL, C, etc.). Design structure (420) may be contained on one or more machine readable medium. For example, design structure (420) may be a text file or a graphical representation of a circuit as described above and shown in FIGS. 1 and 2. Design process (410) preferably synthesizes (or translates) the circuit described above and shown in FIGS. 1 and 2 into a netlist (480), where netlist (480) is, for example, a list of wires, transistors, logic gates, control circuits, I/O, models, etc. that describes the connections to other elements and circuits in an integrated circuit design and recorded on at least one of machine readable medium. For example, the medium may be a storage medium such as a CD, a compact flash, other flash memory, or a hard-disk drive. The medium may also be a packet of data to be sent via the Internet, or other networking suitable means. The synthesis may be an iterative process in which netlist (480) is resynthesized one or more times depending on design specifications and parameters for the circuit.

Design process (410) may include using a variety of inputs; for example, inputs from library elements (430) which may house a set of commonly used elements, circuits, and devices, including models, layouts, and symbolic representations, for a given manufacturing technology (e.g., different technology nodes, 32 nm, 45 nm, 90 nm, etc.), design specifications (440), characterization data (450), verification data (460), design rules (470), and test data files (485) (which may include test patterns and other testing information). Design process (410) may further include, for example, standard circuit design processes such as timing analysis, verification, design rule checking, place and route operations, etc. One of ordinary skill in the art of integrated circuit design can appreciate the extent of possible electronic design automation tools and applications used in design process (410) without deviating from the scope and spirit of the invention. The design structure of the invention is not limited to any specific design flow.

Design process (410) preferably translates a circuit as described above and shown in FIGS. 1 and 2, along with any additional integrated circuit design or data (if applicable), into a second design structure (490). Design structure 490 resides on a storage medium in a data format used for the exchange of layout data of integrated circuits (e.g. information stored in a GDSII (GDS2), GL1, OASIS, or any other suitable format for storing such design structures). Design structure (490) may comprise information such as, for example, test data files, design content files, manufacturing data, layout parameters, wires, levels of metal, vias, shapes, data for routing through the manufacturing line, and any other data required by a semiconductor manufacturer to produce a circuit as described above and shown in FIGS. 1 and 2. Design structure (490) may then proceed to a stage (495) where, for example, design structure (490): proceeds to tape-out, is released to manufacturing, is released to a mask house, is sent to another design house, is sent back to the customer, etc.

Exemplary embodiments of the present invention are described largely in the context of a fully functional computer system for controlling shared access of a media tray. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A design structure embodied in a machine readable storage medium for at least one of designing, manufacturing, and testing a design, the design structure comprising:
an apparatus for controlling shared access of a media tray, the media tray connected to a management module, the media tray virtualized by the management module and connected to a plurality of computing devices for sharing, the apparatus comprising a computer processor, a computer memory operatively coupled to the computer processor, the computer memory having disposed within it computer program instructions capable of:
monitoring communications between the virtualized media tray and a computing device currently connected to the virtualized media tray;
receiving an access request from a requesting computing device not currently connected to the virtualized media tray;
determining, in dependence upon the monitored communications between the virtualized media tray and the computing device currently connected to the virtualized media tray, to switch connection of the virtualized media tray from the computing device currently connected to the virtualized media tray to the requesting computing device; and
switching connection of the virtualized media tray from the computing device currently connected to the virtualized media tray to the requesting computing device.

2. The design structure of claim 1, wherein monitoring communications between the virtualized media tray and a computing device currently connected to the virtualized media tray further comprises:
identifying periods of low activity between the virtualized media tray and the computing device currently connected to the virtualized media tray; and
determining to switch connection of the virtualized media tray from the computing device currently connected to the virtualized media tray to the requesting computing device further comprises:
determining that a current period of communications between the virtualized media tray and the computing device currently connected to the virtualized media tray is a period of low activity.

3. The design structure of claim 1 wherein determining to switch connection of the virtualized media tray from the computing device currently connected to the virtualized media tray to the requesting computing device further comprises further comprises:
identifying no communications between the virtualized media tray and the computing device currently connected to the virtualized media tray for an amount of time greater than a predetermined threshold.

4. The design structure of claim 2 wherein monitoring communications between the virtualized media tray and a computing device currently connected to the virtualized media tray further comprises:
snooping SCSI commands between the virtualized media tray and the computing device currently connected to the virtualized media tray.

5. The design structure of claim 1 wherein switching connection of the virtualized media tray from the computing device currently connected to the virtualized media tray to the requesting computing device further comprises:
addressing, through an out-of-band communications link, a multiplexer connecting the virtualized media tray to the plurality of computing devices with an address associated with the requesting computing device.

6. The design structure of claim 1 wherein the plurality of computing devices are blade servers installed in a blade center.

7. The design structure of claim 1, wherein the design structure comprises a netlist, which describes the apparatus.

8. The design structure of claim 1, wherein the design structure resides on the machine readable storage medium as a data format used for the exchange of layout data of integrated circuits.
